(19) United States
(12) Patent Application Publication
(10) Pub. No.: US 2013/0309342 A1
(43) Pub. Date: Nov. 21, 2013

(54) Mold-Tool Assembly Including Constant-Temperature Heater Assembly for Manifold Assembly

(71) Applicants: Paul R. Blais, South Burlington, VT (US); John Knapp, St. Albans, VT (US); Manon Danielle Belzile, Fairfield, VT (US); Sarah Kathleen Overfield, Colchester, VT (US); Brian Esser, Colchester, VT (US); James Osborne Plumpton, Enosburg Falls, VT (US); Abdeslam Bouti, Swanton, VT (US)

(72) Inventors: Paul R. Blais, South Burlington, VT (US); John Knapp, St. Albans, VT (US); Manon Danielle Belzile, Fairfield, VT (US); Sarah Kathleen Overfield, Colchester, VT (US); Brian Esser, Colchester, VT (US); James Osborne Plumpton, Enosburg Falls, VT (US); Abdeslam Bouti, Swanton, VT (US)

(73) Assignee: Husky Injection Molding Systems Ltd., Bolton, ON (CA)

(21) Appl. No.: 13/822,013

(22) PCT Filed: Sep. 20, 2011
(86) PCT No.: PCT/US11/52238

§ 371 Date: May 24, 2013

Related U.S. Application Data
(60) Provisional application No. 61/385,579, filed on Sep. 23, 2010.

(51) Int. Cl. B29C 45/74

(52) U.S. Cl. CPC B29C 45/74
USPC 425/144

(57) ABSTRACT

A mold-tool assembly (100), comprising: a manifold assembly (102); and a constant-temperature heater assembly (99) being positioned relative to the manifold assembly (102), the constant-temperature heater assembly (99) being configured to convey, in use, a thermal-management fluid (109).

### TECHNICAL FIELD

An aspect generally relates to (and is not limited to) a mold-tool assembly having: a manifold assembly, and a constant-temperature heater assembly positioned relative to the manifold assembly.

### BACKGROUND

The first man-made plastic was invented in Britain in 1851 by Alexander PARKES. He publicly demonstrated it at the 1862 International Exhibition in London, calling the material Parkesine. Derived from cellulose, Parkesine could be heated, molded, and retain its shape when cooled. It was expensive to produce, prone to cracking, and highly flammable. In 1868, American inventor John Wesley HYATT developed a plastic material he named Celluloid, improving on PARKES' concept so that it could be processed into finished form. HYATT patented the first injection molding machine in 1872. It worked like a large hypodermic needle, using a plunger to inject plastic through a heated cylinder into a mold. The industry expanded rapidly in the 1940s because World War II created a huge demand for inexpensive, mass-produced products. In 1946, American inventor James Watson HENDRY built the first screw injection machine. This machine also allowed material to be mixed before injection, so that colored or recycled plastic could be added to virgin material and mixed thoroughly before being injected. In the 1970s, HENDRY went on to develop the first gas-assisted injection molding process. Injection molding machines consist of a material hopper, an injection ram or screw-type plunger, and a heating unit. They are also known as presses, they hold the molds in which the components are shaped. Presses are rated by tonnage, which expresses the amount of clamping force that the machine can exert. This force keeps the mold closed during the injection process. Tonnage can vary from less than five tons to 6000 tons, with the higher figures used in comparatively few manufacturing operations. The amount of total clamp force is determined by the projected area of the part being molded. This projected area is multiplied by a clamp force of from two to eight tons for each square inch of the projected areas. As a rule of thumb, four or five tons per square inch can be used for most products. If the plastic material is very stiff, more injection pressure may be needed to fill the mold, thus more clamp tonnage to hold the mold closed. The required force may also be determined by the material used and the size of the part, larger parts require higher clamping force. With Injection Molding, granular plastic is fed by gravity from a hopper into a heated barrel. As the granules are slowly moved forward by a screw-type plunger, the plastic is forced into a heated chamber, where it is melted. As the plunger advances, the melted plastic is forced through a nozzle that rests against the mold, allowing it to enter the mold cavity through a gate and runner system. The mold remains cold so the plastic solidifies almost as soon as the mold is filled. Mold assembly or die are terms used to describe the tooling used to produce plastic parts in molding. The mold assembly is used in mass production where thousands of parts are produced. Molds are typically constructed from hardened steel, etc. Hot-runner systems are used in molding systems, along with mold assemblies, for the manufacture of plastic articles. Usually, hot-runners systems and mold assemblies are treated as tools that may be sold and supplied separately from molding systems.

### SUMMARY

The inventors have researched a problem associated with known molding systems that is inadvertently manufacture bad-quality molded articles or parts. After much study, the inventors believe they have arrived at an understanding of the problem and its solution, which are stated below, and the inventors believe this understanding is not known to the public. Known heater assemblies used in mold-tool systems (such as hot runner assemblies) include a resistive element (such as nickel chromium wire and generally known as known resistive heater technology), which requires electrical current (that is, electrical power) to be applied to the resistive element in order to generate thermal energy (heating effect), and then the thermal energy is transferred to the mold-tool system. The resistive element is a source of thermal energy and does not take away or remove thermal energy from the mold-tool system. Typically, the known heater assemblies may provide a fixed wattage per linear distance of the resistive element or fixed wattage per area of the surface of the resistive element. The known heater assemblies may be acceptable if the wattage loss is consistent. For known heater assemblies that do not have consistent heat losses, this arrangement may result in excessively low or high temperatures. The inventors believe that in order to counter act this arrangement, the known heater assemblies may be split or separated into multiple segments depending on the requirements of the mold-tool system and/or allowed temperature variation. This solution may inadvertently cause other problems, specifically more heater zones may be required in a temperature controller (for controlling the known heater assemblies), and/or more variation in the temperature of the mold-tool system due to installation variance associated with the known heater assemblies. The examples of the present invention (described below) may provide the following benefits: (i) improved thermal profile of the mold-tool system, (ii) improved balance of flow of melt through the mold-tool system, (iii) reduce inadvertent burning of the resin in the mold-tool system, (iii) reduce the number of thermal control zones that may be required, (iv) provide a self thermal-limiting capability, (v) replace and/or complement the known resistive heater technology with a relatively constant temperature heat source that uses, for example, a thermal-transfer fluid that is used to heat the mold-tool system. The following reference numerals used to describe the examples are indicated in the FIGS.

According to a first example, a mold-tool assembly (100) includes (and is not limited to): a manifold assembly (102) having an outer surface (104) defining a groove (106); and a thermal-management assembly (108) being received in the groove (106), the thermal-management assembly (108) being configured to convey, in use, a thermal-management fluid (109). According to a variation of the first example, the mold-tool assembly (100) is adapted so that the thermal-management assembly (108) includes: a tube assembly (113) being configured to convey, in use, the thermal-management fluid (109).

According to a second example, a mold-tool assembly (100), includes (and is not limited to): a manifold assembly (102); and a thermal-management assembly (108) being positioned relative to the manifold assembly (102), the thermal-management assembly (108) being configured to convey, in use, a thermal-management fluid (109), and wherein: the thermal-management assembly (108) includes: a plate cover (120) covering a groove (106) being defined by the manifold assembly (102), and the thermal-management fluid (109) touches the groove (106) and the plate cover (120).

According to a third example, a mold-tool assembly (100) includes (and is not limited to): a manifold assembly (102); and a thermal-management assembly (108) being positioned relative to the manifold assembly (102), the thermal-management assembly (108) being configured to convey, in use, a thermal-management fluid (109), wherein: the thermal-management assembly (108) includes: a plate cover (120) covering the manifold assembly (102), the plate cover (120) defines a plate groove (107) configured to convey, in use, the thermal-management fluid (109).

According to a fourth example, a mold-tool assembly (100), includes (and is not limited to): a manifold assembly (102); and a thermal-management assembly (108) being positioned relative to the manifold assembly (102), the thermal-management assembly (108) being configured to convey, in use, a thermal-management fluid (109), wherein: the thermal-management assembly 108 includes a plurality of thermal-management paths (122) being defined by the manifold assembly (102), each of the plurality of thermal-management paths (122) being configured to convey, in use, the thermal-management fluid (109), the plurality of thermal-management paths (122) surrounding a melt channel (110) being defined by the manifold assembly (102).

According to a fifth example, a mold-tool assembly (100) includes (and is not limited to): a manifold assembly (102); and a thermal-management assembly (108) being positioned relative to the manifold assembly (102), the thermal-management assembly (108) being configured to convey, in use, a thermal-management fluid (109), wherein: the manifold assembly (102) includes: a manifold body (103) having: a first manifold body (130); and a second manifold body (132), the thermal-management assembly (108) includes: complementary-mating thermal-management paths (119) being defined by the first manifold body (130) and the second manifold body (132), each of the complementary-mating thermal-management paths (119) being configured to convey, in use, the thermal-management fluid (109).

According to a sixth example, a mold-tool assembly (100) includes (and is not limited to): a manifold assembly (102); and a thermal-management assembly (108) being positioned relative to the manifold assembly (102), the thermal-management assembly (108) being configured to convey, in use, a thermal-management fluid (109), wherein: the thermal-management assembly (108) includes: a plate cover (120) defining a plate channel (121), and the thermal-management fluid (109) is received in the plate channel (121).

According to a seventh example, a mold-tool assembly (100) includes (and is not limited to): a manifold assembly (102); and a thermal-management assembly (108) being positioned relative to the manifold assembly (102), the thermal-management assembly (108) being configured to convey, in use, a thermal-management fluid (109), wherein: the thermal-management assembly (108) includes: a bladder assembly (125) defining a bladder channel (117), the thermal-management fluid (109) being received in the bladder channel (117).

According to an eighth example, a mold-tool assembly (100) includes (and is not limited to): a manifold assembly (102); and a thermal-management assembly (108) being positioned relative to the manifold assembly (102), the thermal-management assembly (108) being configured to convey, in use, a thermal-management fluid (109), wherein: the thermal-management assembly (108) includes: a plate cover (120) defining a honeycomb channel (133), the thermal-management fluid (109) received, in use, in the honeycomb channel (133).

According to an ninth example, a mold-tool assembly (100) includes (and is not limited to): a manifold assembly (102); and a thermal-management assembly (108) being positioned relative to the manifold assembly (102), the thermal-management assembly (108) being configured to convey, in use, a thermal-management fluid (109), wherein: the manifold assembly (102) includes: a modular component (189), and the thermal-management assembly (108) is coupled with the modular component (189).

According to an tenth example, a mold-tool assembly (100) includes (and is not limited to): a manifold assembly (102); and a thermal-management assembly (108) being positioned relative to the manifold assembly (102), the thermal-management assembly (108) being configured to convey, in use, a thermal-management fluid (109), wherein: the thermal-management assembly (108) is received, at least in part, in a melt channel (110) defined by the manifold assembly (102). According to a variation of the tenth example, the mold-tool assembly (100) if further adapted so that the thermal-management assembly (108) includes: a tube assembly (113) being received, at least in part, in a melt channel (110) defined by the manifold assembly (102).

According to an eleventh example, a mold-tool assembly (100) includes (and is not limited to): a manifold assembly (102); and a thermal-management assembly (108) being positioned relative to the manifold assembly (102), the thermal-management assembly (108) being configured to convey, in use, a thermal-management fluid (109), wherein: the thermal-management assembly (108) is attached to a surface of the manifold assembly (102).

According to a twelfth example, a mold-tool assembly (100) includes (and is not limited to): a manifold assembly (102); and a thermal-management assembly (108) being positioned relative to the manifold assembly (102), the thermal-management assembly (108) being configured to convey, in use, a thermal-management fluid (109), wherein: the thermal-management assembly (108) is included in a backing plate (142) of the manifold assembly (102), and the manifold assembly (102) is in contact with the backing plate (142) via a thermal-transfer assembly (140). According to a first variation of the twelfth example, the mold-tool assembly (100) is adapted so that the thermal-management assembly (108) is included in a puck assembly (144) of a backing plate (142) of the manifold assembly (102), and the manifold assembly (102) is in contact with the backing plate (142) via a thermal-transfer assembly (140). According to a second variation of the twelfth example, the mold-tool assembly (100) is adapted so that the thermal-management assembly (108) is included in a heat exchanger (150) being supported by a backing plate (142) of the manifold assembly (102), and the manifold assembly (102) is in contact with the backing plate (142) via a thermal-transfer assembly (140).

According to a thirteenth example, a mold-tool assembly (100) includes (and is not limited to): a mold-tool assembly (100), comprising: a manifold assembly (102); and a constant-temperature heater assembly (99) being positioned relative to the manifold assembly (102), the constant-temperature heater assembly (99) being configured to convey, in use, a thermal-management fluid (109).

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

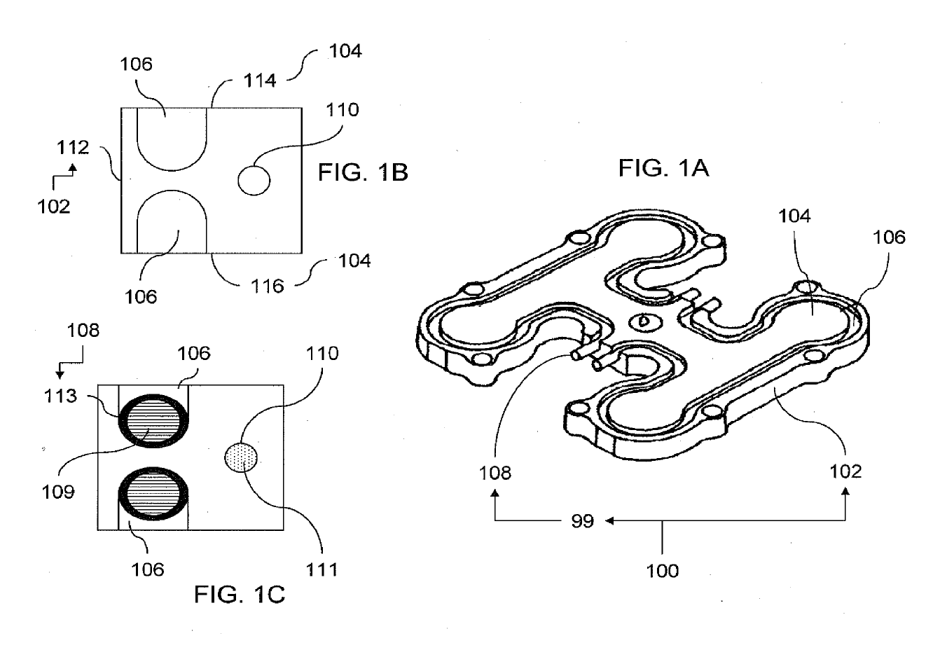

FIGS. 1A, 1B, 1C, 2A, 2B, 2C, 2D, 3, 4A, 4B, 4C, 4D, 5, 6, 7, 8, 9, 10, 11, 12 depict the examples of a mold-tool assembly (100).

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENTS (EXAMPLES)

The mold-tool assembly (100) may include components that are known to persons skilled in the art, and these known components will not be described here; these known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9). It will be appreciated that for the purposes of this document, the phrase “includes (and is not limited to)” is equivalent to the word “comprising”. The word “comprising” is a transitional phrase or word that links the preamble of a patent claim to the specific elements set forth in the claims. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim.

The examples of the mold-tool assembly (100), and/or variations and combinations and permutations of the examples of the mold-tool assembly (100), may replace and/or complement the known heater resistive technology used in known mold-tool system. The examples of the mold-tool assembly (100) may be used with a thermal-management assembly (108), which may be a constant-temperature heater assembly (99). A constant-temperature heater is a heater than maintains the same internal temperature no matter the external heat losses or heat gains associated with the mold-tool assembly (100). For example, one way to achieve the constant-temperature heater is to use a thermal-management fluid (109) passing through, for example, a tube or a pipe. The heat transfer may be supplied at a fixed temperature, and with the right amount of flow rate may exit close to the same temperature resulting in a constant-temperature heater assembly (99). Referring to FIG. 1, the mold-tool assembly (100) includes (and is not limited to): a manifold assembly (102), and a constant-temperature heater assembly (99) being positioned relative to the manifold assembly (102) and the constant-temperature heater assembly (99) is configured to convey, in use, a thermal-management fluid (109). The mold-tool assembly (100) may include (and is not limited to): a hot runner system, or a cold runner system. The constant-temperature heater assembly (99) may be accomplished in accordance with many examples, which are described below:

FIG. 1A depicts a perspective view of a mold-tool assembly (100). According to the example depicted in FIG. 1A, the mold-tool assembly (100) may include (and is not limited to): (i) a manifold assembly (102), and (ii) a thermal-management assembly (108) that is positioned relative to the manifold assembly (102). The thermal-management assembly (108) is configured to convey, in use, a thermal-management fluid (109). According to a variation of the depicted example, the manifold assembly (102) has an outer surface (104) defining a groove (106), and the thermal-management assembly (108) is received in the groove (106). In addition, the thermal-management assembly (108) may include (and is not further limited to): a tube assembly (113) that is configured to convey, in use, the thermal-management fluid (109). According to another variation of the depicted example, the mold-tool assembly (100) may include (and is not limited to): the manifold assembly (102) having an outer surface (104) defining a groove (106), and the thermal-management assembly (108) that is positioned relative to the groove (106): for example, the thermal-management assembly (108) may be received in the groove (106). The thermal-management assembly (108) may be configured to convey, in use, the thermal-management fluid (109) (such as oil, etc). The thermal-management fluid (109) may be defined as: a continuous, amorphous substance whose molecules move freely past one another and that has the tendency to assume the shape of its container, such as a liquid but not a gas. The thermal-management fluid (109) may transfer thermal energy and/or may take away or remove thermal energy. The groove (106) may be defined as: a long narrow furrow and/or a channel and/or channel.

FIGS. 1B, 1C depict cross sectional side views of the mold-tool assembly (100). According to the examples depicted in FIGS. 1B, 1C, the thermal-management assembly (108) may further include a tube assembly (113) that is configured to convey, in use, the thermal-management fluid (109). The tube assembly (113) may be a hollow cylinder that conveys a fluid or functions as a passage. The tube assembly (113) may be inflatable or ridged. The specific shape of the cylinder is of matter of convenience. The tube assembly (113) may be attached to the manifold assembly (102) and/or to the groove (106) by brazing, potting, compounding, welding, etc or by being pressed into the groove (106). The manifold assembly (102) may include a manifold body 103 that defines a melt channel (110). A melt (111) (also known as a resin, etc) is conveyed in the melt channel (110). The groove (106) may be defined on a top-facing outer surface (114) of the manifold assembly (102), or may be defined on a bottom-facing surface (116) of the manifold assembly (102), or may be defined on both (in combination) the top-facing outer surface (114) and the bottom-facing surface (116).

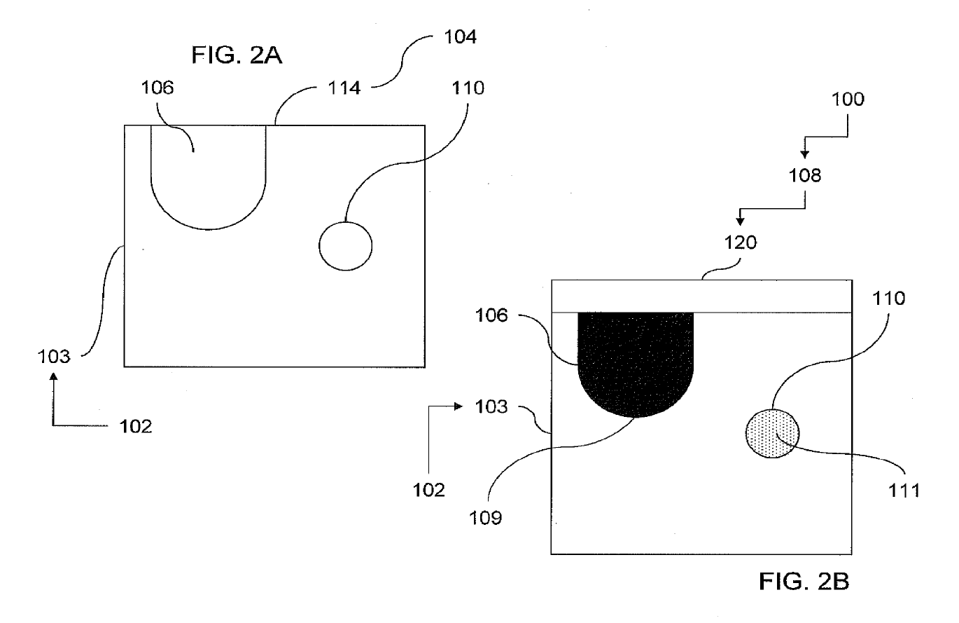

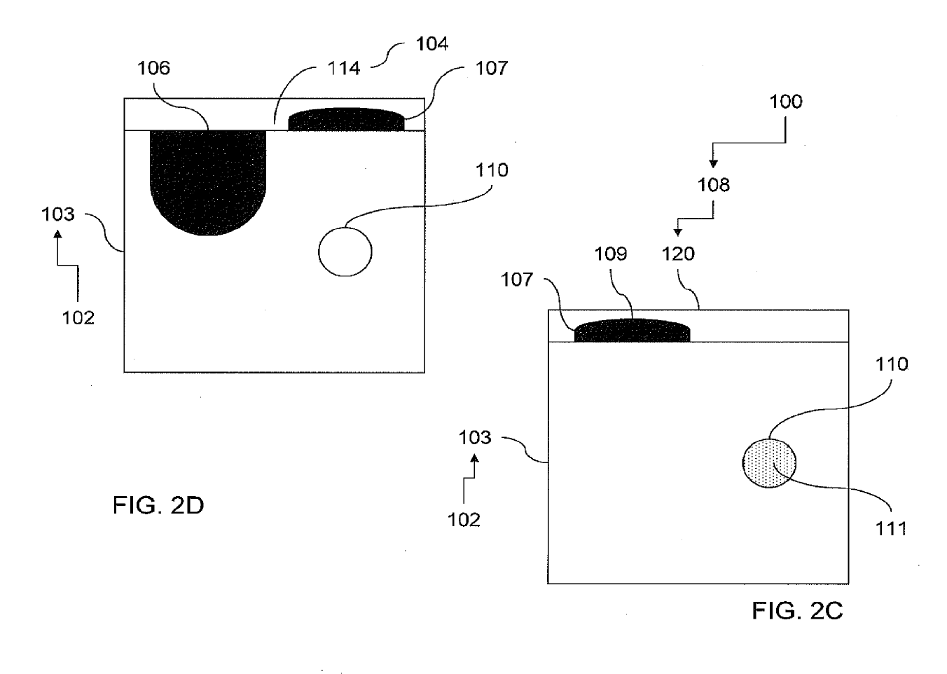

FIGS. 2A, 2B depict cross sectional side views of the mold-tool assembly (100). According to the examples depicted in FIGS. 2A, 2B, the thermal-management assembly (108) may further include (and is not limited to) a plate cover (120) for covering the groove (106). The thermal-management fluid (109) touches the groove (106) and the plate cover (120). It is understood that the plate cover (120) may be attached to the manifold assembly (102) by using many ways (such as): removably attachable mechanisms (such as screws, bolts), permanent bonding, such as welding, brazing, etc.

FIG. 2C, 2D are cross sectional side views of the mold-tool assembly (100). According to the examples depicted in FIGS. 2C, 2D, the plate cover (120) defines a plate groove (107) that is configured to convey, in use, the thermal-management fluid (109). The groove (106) and plate groove (107) may be defined by manifold assembly (102) and by the plate cover (120) respectively.

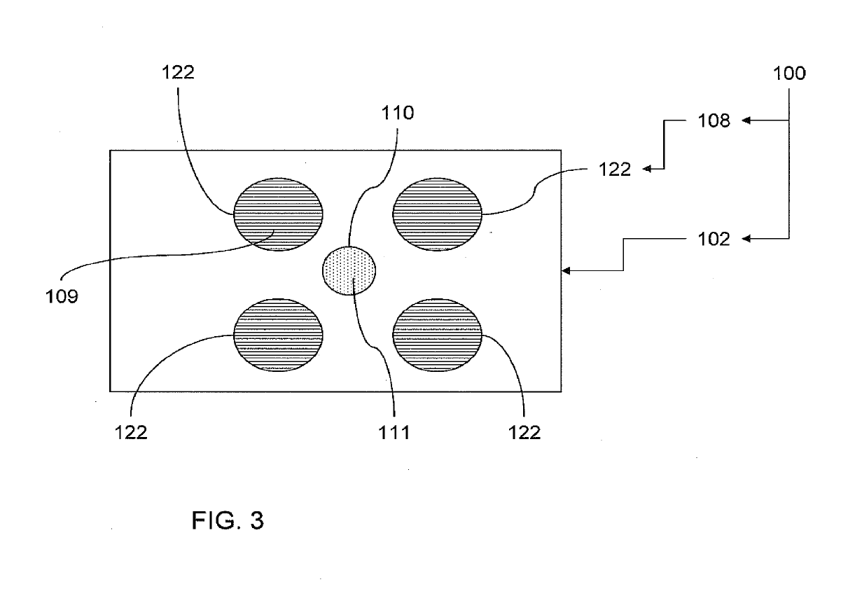

FIG. 3 depict a cross sectional view of the mold-tool assembly (100). According to the example depicted in FIG. 3, the thermal-management assembly 108 may further include (and is not limited to) a plurality of thermal-management paths (122) that are defined by the manifold assembly (102). Each of the plurality of thermal-management paths (122) are configured to convey, in use, the thermal-management fluid (109). The plurality of thermal-management paths (122) surround the melt channel (110) that is defined by the manifold assembly (102). The are many ways to form the thermal-management paths (122), such as: gun drilled holes, 3D metal printing process, etc.

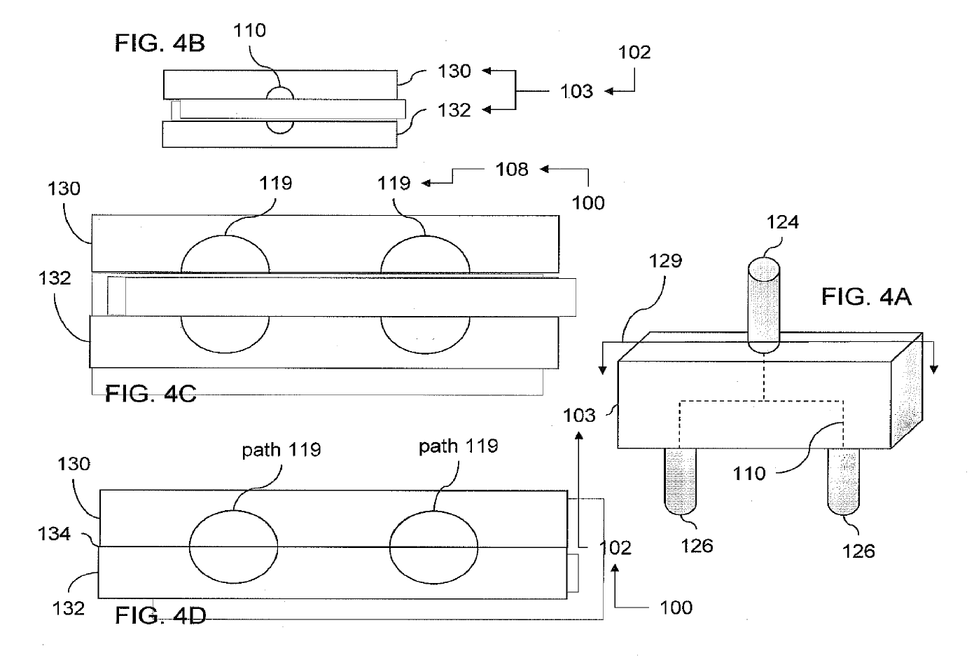

FIGS. 4A, 4B, 4C, 4D depict perspective views and cross sectional views of the mold-tool assembly (100). According to the examples depicted in FIGS. 4A, 4B, 4C, 4D, the manifold assembly (102) may include (and is not limited to) a split manifold. That is, the manifold assembly (102) may include (and is not limited to): a manifold body (103) having: a first manifold body (130), and a second manifold body (132). The thermal-management assembly (108) includes: complementary-mating thermal-management paths (119) that are defined by the first manifold body (130) and the second manifold body (132). Each of the complementary-mating thermal-management paths (119) is configured to convey, in use, the thermal-management fluid (109). The complementary-mating thermal-management paths (119) may be formed on a surface of the first manifold body (130) and the second manifold body (132). The manifold assembly (102) may define an inlet (124), outlets (126) and the melt channel (110) may connects the inlet (124) with the outlets (126). Cross sectional views (FIGS. 4A, 4C, 4D) of the mold-tool assembly (100) are taken along a cross sectional line (129). FIG. 4B depicts a top view of the manifold assembly (102). FIGS. 4C, 4D depict bottom views of the manifold assembly (102). FIG. 4D depicts a join line 134 where the first manifold body (130) and the second manifold body (132) are joined, by various methods, such as welding, etc.

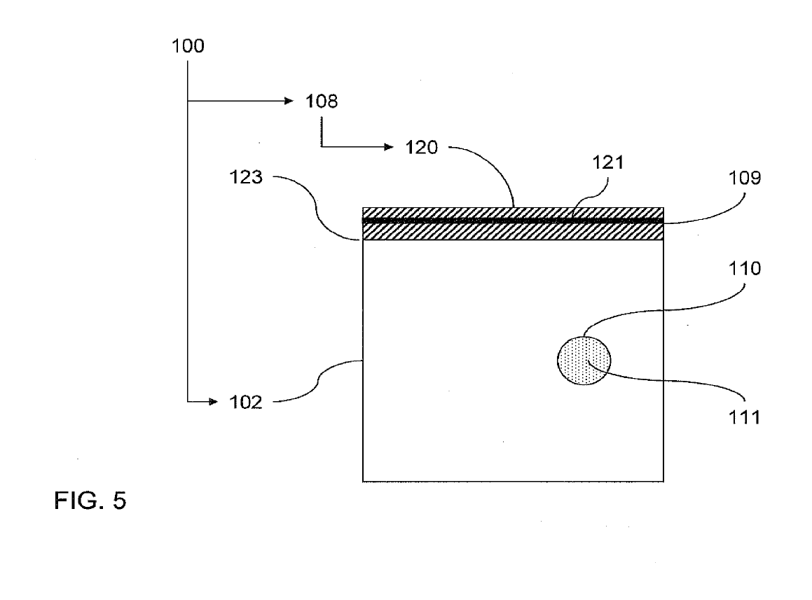

FIG. 5 depicts a schematic representation of the mold-tool assembly (100). According to the example depicted in FIG. 5, the thermal-management assembly (108) may further include (and is not limited to) a plate cover (120) defining a plate channel (121). The thermal-management fluid (109) is received in the plate channel (121). The plate cover (120) may be attached and/or bonded to the surface of the manifold assembly (102) along a bonding surface (123).

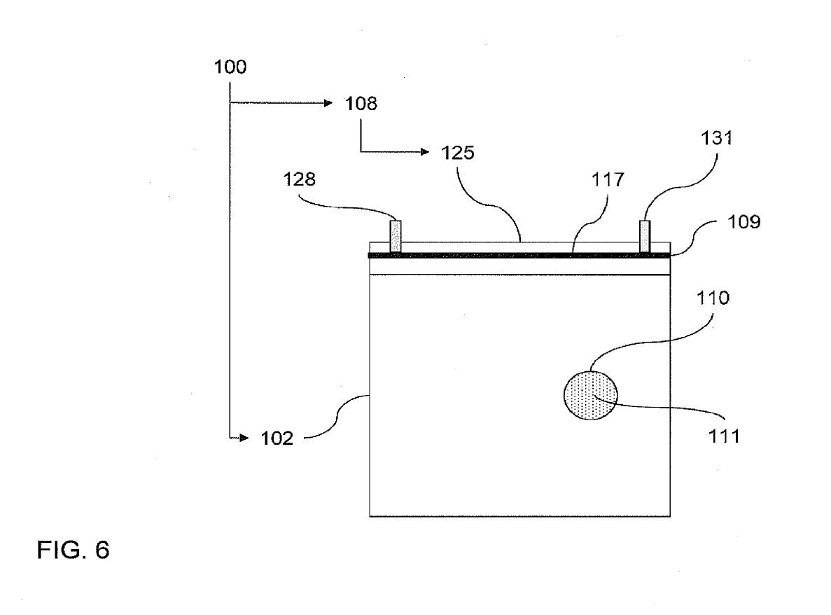

FIG. 6 depicts a schematic representation of the mold-tool assembly (100). According to the example depicted in FIG. 6, the thermal-management assembly (108) may further include (and is not limited to): a bladder assembly (125) defining a bladder channel (117). The thermal-management fluid (109) may be received in the bladder channel (117). The bladder channel (117) may have a bladder inlet (128), and a bladder outlet (131).

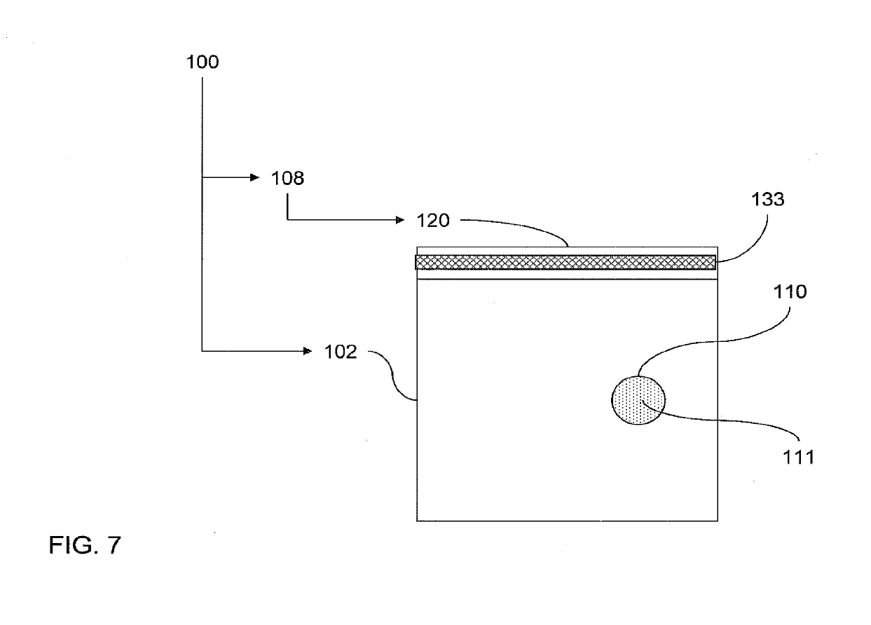

FIG. 7 depicts a schematic representation of the mold-tool assembly (100). According to the example depicted in FIG. 7, the thermal-management assembly (108) may further include: a plate cover (120) defining a honeycomb channel (133). The thermal-management fluid (109) may be received, in use, in the honeycomb channel (133). The the honeycomb channel (133) may have micro channels, baffles, etc. The honeycomb channel (133) may be bonded, etc, to the manifold assembly (102).

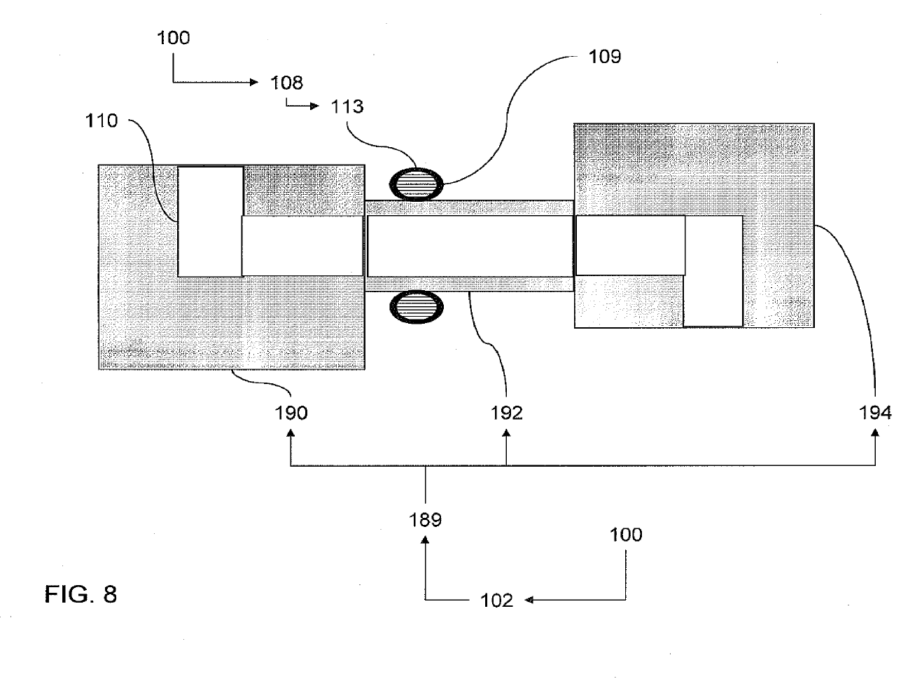

FIG. 8 depicts a schematic representation of the mold-tool assembly (100). According to the example depicted in FIG. 8, the manifold assembly (102) may further include (and is not limited to): a modular component (189), and the thermal-management assembly (108) may be coupled with the modular component (189). By way of example, the modular component (189) may include (and is not limited to): a modular runner distribution block (190), a modular conduit connection body (192), a modular runner drop block (194). The heat transfer fluid may be used on a single manifold or on a multi-component manifold system, such as a cross manifold with main manifolds, or on a low cavity manifold system (distributor, tubes and drop blocks, etc).

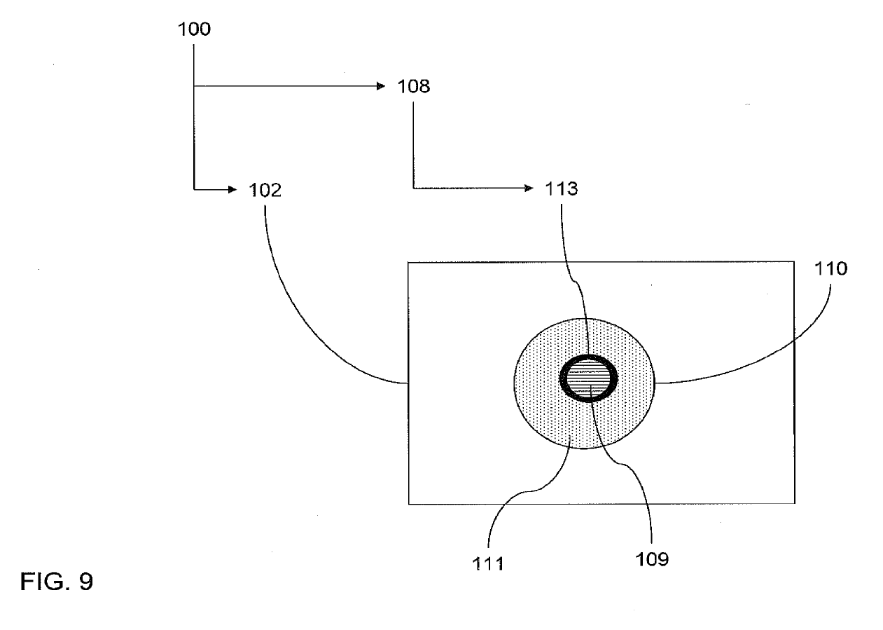

FIG. 9 depicts a schematic representation of the mold-tool assembly (100). According to the example depicted in FIG. 9, the thermal-management assembly (108) may be received, at least in part, in the melt channel (110) defined by the manifold assembly (102). In addition, the thermal-management assembly (108) may include (and is not limited to): a tube assembly (113) that is received, at least in part, in the melt channel (110) defined by the manifold assembly (102). Supports may be used to support and position the thermal-management assembly (108) in the melt channel (110).

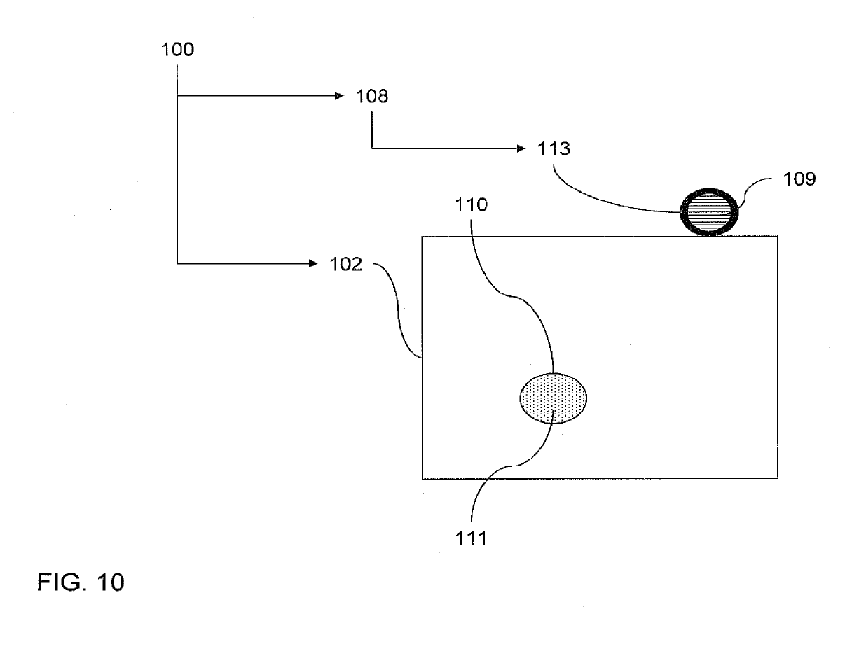

FIG. 10 depicts a schematic representation of the mold-tool assembly (100). According to the example depicted in FIG. 10, the thermal-management assembly (108) may be attached to a surface of the manifold assembly (102), and thermal-management assembly (108) may include the tube assembly (113). The method of attachment of the tube assembly (113) to the manifold assembly (102) may be by any suitable manufacturing method such as welding or brazing, etc (for example).

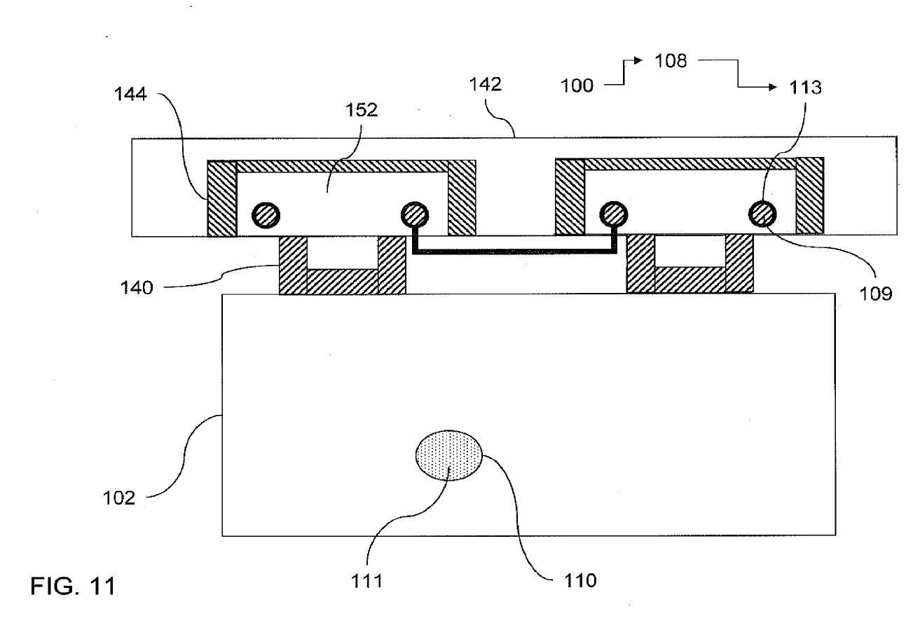

FIG. 11 depicts a schematic representation of the mold-tool assembly (100). According to the example depicted in FIG. 11, the thermal-management assembly (108) may be included in a backing plate (142) of the manifold assembly (102). The manifold assembly (102) may be in contact with the backing plate (142) via a thermal-transfer assembly (140). According to a variation, the thermal-management assembly (108) may be included in a puck assembly (144) of a backing plate (142), and the manifold assembly (102) is in contact with the backing plate (142) via a thermal-transfer assembly (140). The thermal-transfer assembly (140) may include (and is not limited to) an insulator element (152) for use with the manifold assembly (102), which may represent a form of heat loss, and for this case the insulator element (152) transfers, in use, thermal energy from the puck assembly (144) to the manifold assembly (102). The puck assembly (144) may include a piece or block of metal (steel, copper, etc) that is embedded in and/or attached to the backing plate (142). The puck assembly (144) may be insulated from the backing plate (142). The puck assembly (144) may be designed to have heat transfer fluid flow through its body. The puck assembly (144) may heat up due to heat transfer fluid and transfer the heat to the manifold assembly (102). In this configuration the temperature gradient from a manifold surface to the puck surface of the puck assembly (144) may be tuned (that is, reduced or increased) to a value that may be required for the best or optimum function of the mold-tool assembly (100). In the case of a thermoset resin molding system (not depicted), it may be desirable to keep the mold-tool assembly (100) runner and the mold cavity hot (relatively hotter), and therefore, the puck assembly (144) is cooled as may be required for processing a thermoset resin. Conversely, in the case for a thermoplastic resin molding system (not depicted), the puck assembly (144) may be heated as may be required for processing thermoplastic resins.

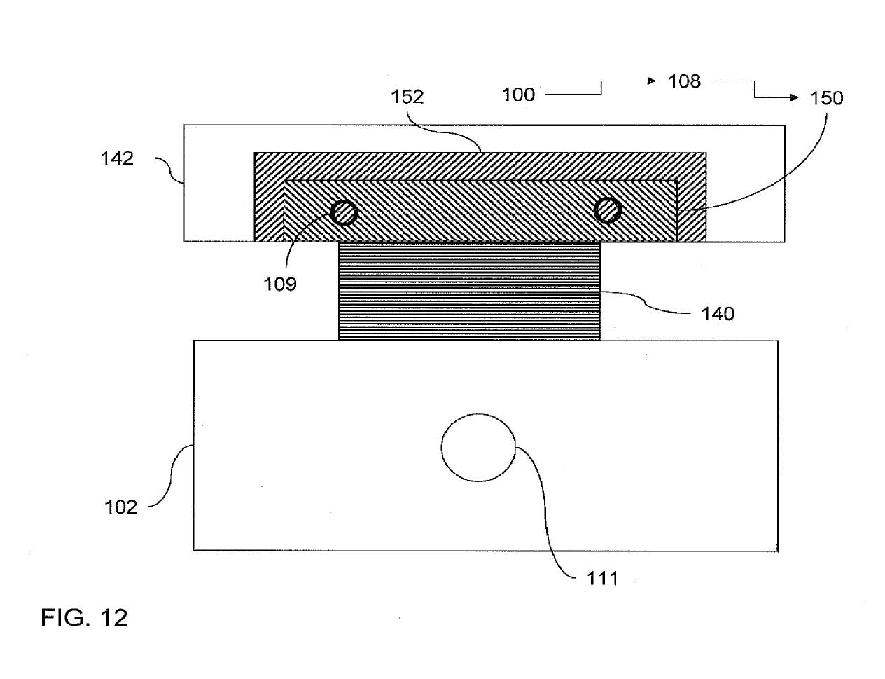

FIG. 12 depicts a schematic representation of the mold-tool assembly (100). According to the example depicted in FIG. 12, the thermal-management assembly (108) may be included in a heat exchanger (150) that is supported by a backing plate (142). The manifold assembly (102) may be in contact with the backing plate (142) via a thermal-transfer assembly (140). The thermal-management fluid (109) may be used to heat the heat exchanger (150). Heat may be conducted from the heat exchanger (150) to the manifold assembly (102) via the heat transfer block. The insulator element (152) may be used to keep the backing plate (142) cool or hot depending on the type of resin (melt) to be processed, and molding conditions requirements, and to maximize the efficiency of the heat exchanger (150). As in the embodiment of FIG. 11 the heat exchanger (150) may be be heated for the purpose of processing thermoplastic resins, or may be cooled for the purpose of processing thermosetting resins, for example.

### ADDITIONAL DESCRIPTION

The following clauses provide further description of the aspects and/or variations of the examples: Clause (1): a mold-tool assembly (100), comprising: a manifold assembly (102); and a thermal-management assembly (108) being positioned relative to the manifold assembly (102), the thermal-management assembly (108) configured to convey, in use, a thermal-management fluid (109). Clause (2): the mold-tool assembly (100) of clause (1), wherein: the manifold assembly (102) has an outer surface (104) defining a groove (106); and the thermal-management assembly (108) is received in the groove (106). Clause (3): the mold-tool assembly (100) of any clause mentioned in this paragraph, wherein: the thermal-management assembly (108) includes: a tube assembly (113) being configured to convey, in use, the thermal-management fluid (109). Clause (4): the mold-tool assembly (100) of any clause mentioned in this paragraph, wherein: the thermal-management assembly (108) includes: a plate cover (120) covering a groove (106) being defined by the manifold assembly (102), and the thermal-management fluid (109) touches the groove (106) and the plate cover (120). Clause (5): the mold-tool assembly (100) of any clause mentioned in this paragraph, wherein: the thermal-management assembly (108) includes: a plate cover (120) covering a groove (106) being defined by the manifold assembly (102), and the thermal-management fluid (109) touches the groove (106) and the plate cover (120), the plate cover (120) defines a plate groove (107) configured to convey, in use, the thermal-management fluid (109). Clause (6): the mold-tool assembly (100) of any clause mentioned in this paragraph, wherein: the thermal-management assembly 108 includes: a plurality of thermal-management paths (122) being defined by the manifold assembly (102), each of the plurality of thermal-management paths (122) being configured to convey, in use, the thermal-management fluid (109), the plurality of thermal-management paths (122) surrounding a melt channel (110) being defined by the manifold assembly (102). Clause (7): the mold-tool assembly (100) of any clause mentioned in this paragraph, wherein: the manifold assembly (102) includes: a manifold body (103) having: a first manifold body (130); and a second manifold body (132), the thermal-management assembly (108) includes: complementary-mating thermal-management paths (119) being defined by the first manifold body (130) and the second manifold body (132), each of the complementary-mating thermal-management paths (119) being configured to convey, in use, the thermal-management fluid (109). Clause (8): the mold-tool assembly (100) of any clause mentioned in this paragraph, wherein: the thermal-management assembly (108) includes: a plate cover (120) defining a plate channel (121), and the thermal-management fluid (109) is received in the plate channel (121). Clause (9): the mold-tool assembly (100) of any clause mentioned in this paragraph, wherein: the thermal-management assembly (108) includes: a bladder assembly (125) defining a bladder channel (117), the thermal-management fluid (109) being received in the bladder channel (117). Clause (10): the mold-tool assembly (100) of any clause mentioned in this paragraph, wherein: the thermal-management assembly (108) includes: a plate cover (120) defining a honeycomb channel (133), the thermal-management fluid (109) received, in use, in the honeycomb channel (133). Clause (11): the mold-tool assembly (100) of any clause mentioned in this paragraph, wherein: the manifold assembly (102) includes: a modular component (189), and the thermal-management assembly (108) is coupled with the modular component (189). Clause (12): the mold-tool assembly (100) of any clause mentioned in this paragraph, wherein: the thermal-management assembly (108) is received, at least in part, in a melt channel (110) defined by the manifold assembly (102). Clause (13): the mold-tool assembly (100) of any clause mentioned in this paragraph, wherein: the thermal-management assembly (108) includes: a tube assembly (113) being received, at least in part, in a melt channel (110) defined by the manifold assembly (102). Clause (14): the mold-tool assembly (100) of any clause mentioned in this paragraph, wherein: the thermal-management assembly (108) is attached to a surface of the manifold assembly (102). Clause (15): the mold-tool assembly (100) of any clause mentioned in this paragraph, wherein: the thermal-management assembly (108) is included in a backing plate (142) of the manifold assembly (102), and the manifold assembly (102) is in contact with the backing plate (142) via a thermal-transfer assembly (140). Clause (16): the mold-tool assembly (100) of any clause mentioned in this paragraph, wherein: the thermal-management assembly (108) is included in a puck assembly (144) of a backing plate (142) of the manifold assembly (102), and the manifold assembly (102) is in contact with the backing plate (142) via a thermal-transfer assembly (140). Clause (17): the mold-tool assembly (100) of any clause mentioned in this paragraph, wherein: the thermal-management assembly (108) is included in a heat exchanger (150) being supported by a backing plate (142) of the manifold assembly (102), and the manifold assembly (102) is in contact with the backing plate (142) via a thermal-transfer assembly (140). Clause (18) a mold-tool assembly (100), comprising: a manifold assembly (102); and a constant-temperature heater assembly (99) being positioned relative to the manifold assembly (102), the constant-temperature heater assembly (99) being configured to convey, in use, a thermal-management fluid (109).

It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (and is not limited to)” is equivalent to the word “comprising”. It is noted that the foregoing has outlined the non-limiting embodiments (examples). The description is made for particular non-limiting embodiments (examples). It is understood that the non-limiting embodiments are merely illustrative as examples.

What is claimed is:

1. A mold-tool assembly (100), comprising:
a manifold assembly (102); and
a constant-temperature heater assembly (99) being positioned relative to the manifold assembly (102), the constant-temperature heater assembly (99) being configured to convey, in use, a thermal-management fluid (109).

2. The mold-tool assembly (100) of claim 1, wherein:
the constant-temperature heater assembly (99) includes:
a thermal-management assembly (108) being positioned relative to the manifold assembly (102), the thermal-management assembly (108) being configured to convey, in use, the thermal-management fluid (109).

3. The mold-tool assembly (100) of claim 2, wherein:
the manifold assembly (102) has an outer surface (104) defining a groove (106); and
the thermal-management assembly (108) is received in the groove (106).

4. The mold-tool assembly (100) of claim 3, wherein:
the thermal-management assembly (108) includes:
a tube assembly (113) being configured to convey, in use, the thermal-management fluid (109).

5. The mold-tool assembly (100) of claim 2, wherein:
the thermal-management assembly (108) includes:
a plate cover (120) covering a groove (106) being defined by the manifold assembly (102), and the thermal-management fluid (109) touches the groove (106) and the plate cover (120).

6. The mold-tool assembly (100) of claim 2, wherein:
the thermal-management assembly (108) includes:
a plate cover (120) covering a groove (106) being defined by the manifold assembly (102), and the thermal-management fluid (109) touches the groove (106) and the plate cover (120), and
the plate cover (120) defines a plate groove (107) configured to convey, in use, the thermal-management fluid (109).

7. The mold-tool assembly (100) of claim 2, wherein:
the thermal-management assembly (108) includes:
a plurality of thermal-management paths (122) being defined by the manifold assembly (102), each of the plurality of thermal-management paths (122) being configured to convey, in use, the thermal-management fluid (109), the plurality of thermal-management paths (122) surrounding a melt channel (110) being defined by the manifold assembly (102).

8. The mold-tool assembly (100) of claim 2, wherein:
the manifold assembly (102) includes:
a manifold body (103) having:
a first manifold body (130); and
a second manifold body (132),
the thermal-management assembly (108) includes:
complementary-mating thermal-management paths (119) being defined by the first manifold body (130) and the second manifold body (132), each of the complementary-mating thermal-management paths (119) being configured to convey, in use, the thermal-management fluid (109).

9. The mold-tool assembly (100) of claim 2, wherein:
the thermal-management assembly (108) includes:
a plate cover (120) defining a plate channel (121), and the thermal-management fluid (109) is received in the plate channel (121).

10. The mold-tool assembly (100) of claim 2, wherein:
the thermal-management assembly (108) includes:
a bladder assembly (125) defining a bladder channel (117), the thermal-management fluid (109) being received in the bladder channel (117).

11. The mold-tool assembly (100) of claim 2, wherein:
the thermal-management assembly (108) includes:
a plate cover (120) defining a honeycomb channel (133), the thermal-management fluid (109) received, in use, in the honeycomb channel (133).

12. The mold-tool assembly (100) of claim 2, wherein:
the manifold assembly (102) includes:
a modular component (189), and
the thermal-management assembly (108) is coupled with the modular component (189).

13. The mold-tool assembly (100) of claim 2, wherein:
the thermal-management assembly (108) is received, at least in part, in a melt channel (110) defined by the manifold assembly (102).

14. The mold-tool assembly (100) of claim 2, wherein:
the thermal-management assembly (108) includes:
a tube assembly (113) being received, at least in part, in a melt channel (110) defined by the manifold assembly (102).

15. The mold-tool assembly (100) of claim 2, wherein:
the thermal-management assembly (108) is attached to a surface of the manifold assembly (102).

16. The mold-tool assembly (100) of claim 2, wherein:
the thermal-management assembly (108) is included in a backing plate (142) of the manifold assembly (102), and the manifold assembly (102) is in contact with the backing plate (142) via a thermal-transfer assembly (140).

17. The mold-tool assembly (100) of claim 2, wherein:
the thermal-management assembly (108) is included in a puck assembly (144) of a backing plate (142) of the manifold assembly (102), and the manifold assembly (102) is in contact with the backing plate (142) via a thermal-transfer assembly (140).

18. The mold-tool assembly (100) of claim 2, wherein:
the thermal-management assembly (108) is included in a heat exchanger (150) being supported by a backing plate (142) of the manifold assembly (102), and the manifold assembly (102) is in contact with the backing plate (142) via a thermal-transfer assembly (140).
